(19) United States
(12) Patent Application Publication
(10) Pub. No.: US 2025/0166382 A1
(43) Pub. Date: May 22, 2025

(54) Risk Adjusted Vegetation Management System and Method

(71) Applicant: Robert Kabera, Decatur, GA (US)

(72) Inventor: Robert Kabera, Decatur, GA (US)

(21) Appl. No.: 18/770,619

(22) Filed: Jul. 11, 2024

Related U.S. Application Data
(60) Provisional application No. 63/636,085, filed on Apr. 18, 2024.
(60) Provisional application No. 63/527,579, filed on Jul. 19, 2023.

(51) Int. Cl. G06V 20/52; G01S 17/89; G06V 20/10

(52) U.S. Cl. CPC G06V 20/52; G01S 17/89; G06V 20/188

(57) ABSTRACT

A method comprising receiving geographic data and a first LIDAR imagery data of a coordinate location from a satellite. Storing the geographic data and the first LIDAR imagery data of the coordinate location in a database installed on a server coupled to a network. Assigning a first threat level to the first LIDAR imagery data. Receiving the geographic data and a second LIDAR imagery data from the coordinate location from the satellite. Storing the geographic data and the second LIDAR imagery data of the coordinate location in the database. Assigning a second threat level to the second LIDAR imagery data. Determining a critical threat level from the first LIDAR imagery data and the second LIDAR imagery data. Alerting a device coupled to the network of the critical threat level, the device being owned by an entity. Dispatching the entity to the coordinate location to eliminate the threat.

### CROSS-REFERENCE TO RELATED APPLICATIONS

This application claims the benefit of prior-filed provisional application No. 63/527,579 filed on Jul. 18, 2023. This application also claims the benefit of prior-filed provisional application No. 63/636,085 filed on Apr. 18, 2024.

### BACKGROUND

Since the advent of electricity, society has made tremendous strides in providing electrical power to communities and individuals. One such method included constructing a network of above ground utility lines that are interconnected between power distribution companies and communities. This utility network can cover a span of many miles in many dense cities. Unfortunately, this network coverage may create the potential of utility line interference or damage. One potential hazard includes vegetation, such as trees, bushes, and other similar vegetations. Damage caused by the overgrowth of trees can impact utility lines and cause fires and outages, which incurs significant cost to municipalities, communities, and individuals. The rate at which vegetation may encroach a utility line is difficult to determine and difficult to mitigate. Mitigating potential damaged caused by vegetation overgrowth along a utility distribution network is a challenge.

### BRIEF DESCRIPTION OF THE DRAWINGS

FIG. 1 is a schematic illustration of a flow chart showing a LIDAR satellite receiving geographic data, a LIDAR imagery data, and a coordinate location, and storing that data on a server.

FIG. 2 is a schematic illustration of a flow chart showing a server receiving geographic data, a LIDAR imagery data, and a coordinate location, and alerting a device that subsequently dispatches an entity.

FIG. 3 is a flow chart of a first section of a method of determining a critical threat level from geographic data, LIDAR imagery data, and a coordinate location.

FIG. 4 is a flow chart of a second section of the method of determining a critical threat level from geographic data, LIDAR imagery data, and the coordinate location.

FIG. 5 is a flow chart of a third section of the method of determining a critical threat level from geographic data, LIDAR imagery data, and the coordinate location.

FIG. 6 is a flow chart of a fourth section of the method of determining a critical threat level from geographic data, LIDAR imagery data, and the coordinate location.

FIG. 7 is a flow chart of a fifth section of the method of determining a critical threat level from geographic data, LIDAR imagery data, and the coordinate location.

FIG. 8 is a flow chart of a sixth section of the method of determining a critical threat level from geographic data, LIDAR imagery data, and the coordinate location.

FIG. 9 is a flow chart of a method of determining a critical threat level from geographic data, LIDAR imagery data, and a coordinate location.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

Since the beginning of recorded history, communities and societies have attempted to create methods of generating power to relieve difficult tasks. Such methods include, starting fires to generate heat; utilizing the power of river streams by creating water wheels; and utilizing gravity by creating pulley-systems. The continued evolution of such endeavors has unleashed a variety of methods of generating power. Such innovations have catapulted humankind into a technological revolution that has resulted in innovations such as wireless networks to artificial intelligence operated computer systems.

Other methods have included constructing networks of above ground utility lines that are interconnected between power distribution companies and communities for the purpose of distributing electrical power. This type of network system can cover a span of many miles in many urban and rural communities. Unfortunately, this network coverage may create the potential of utility line interference or damage. One potential hazard includes vegetation, such as trees, bushes, and other similar vegetations. Damage caused by the overgrowth of trees can impact utility lines and cause fires and outages, which incurs significant cost to municipalities, communities, and individuals. The rate at which vegetation may encroach a utility line is difficult to determine and difficult to mitigate. Thus, the embodiments described herein are to a method and system that prevents the overgrowth of vegetation on utility network systems.

For example, the embodiments described herein may include software-powered systems specifically designed for remote monitoring, analysis of satellite imagery, light detection and ranging (hereinafter “LIDAR”) point cloud analysis, surveying, and inspection of utility distribution networks. The system may include methods that allow users and organizations to effectively monitor and evaluate vegetation encroachment on power lines and pole components, enabling proactive maintenance and risk mitigation. The system includes capabilities for extracting LIDAR point cloud data and satellite imagery within the utility distribution system's right-of-way. The system analyzes the height and proximity of vegetation to the distribution system. The integrated software incorporates algorithms for assessing threat levels of vegetation in utility distribution networks. Heat maps are generated allowing for the overview of potential risks. The integrated software facilitates risk-adjusted trimming, pricing, and ticketing process, enhancing the efficiency and accuracy of vegetation management operations.

A critical threat level system and method notifies users or organizations of a list and location of extreme level-five to their email or other similar notification systems. The critical threat level system also notifies individuals and organizations of new threats. In one embodiment, the system includes executing the method more than once, thus comparing recent satellite imagery data with prior satellite imagery data allowing for the assessment of the current threat level, which all can be viewed and integrated into actionable items through a website dashboard.

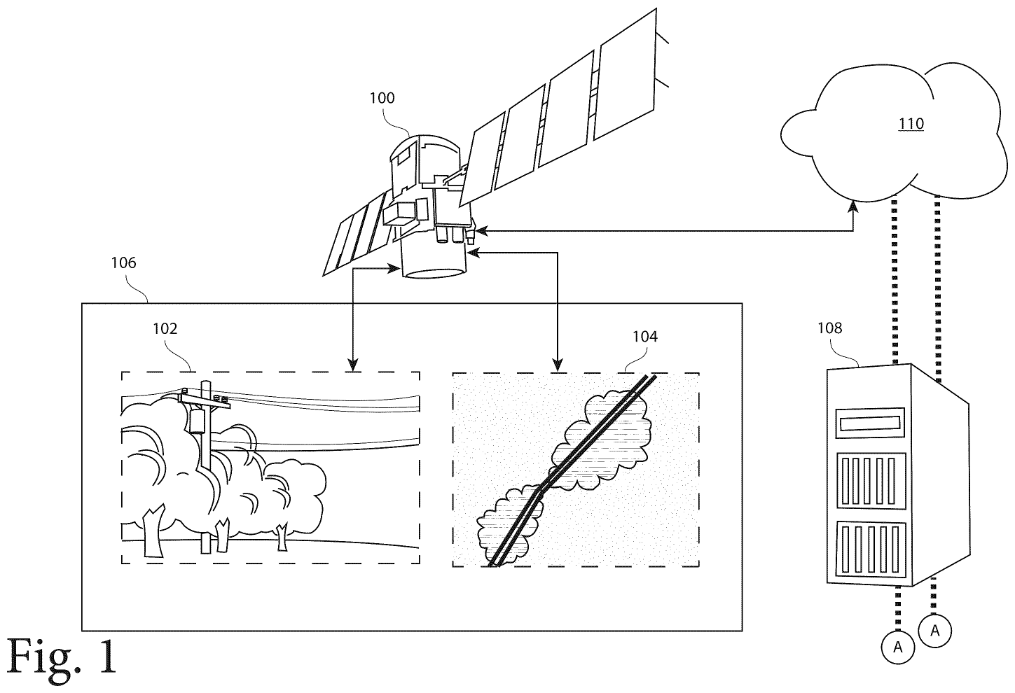

The method by which this system operates is illustrated in the figures. For example, FIG. 1 is a schematic illustration of a flow chart showing a LIDAR satellite receiving geographic data, a LIDAR imagery data, and a coordinate location, and storing that data on a server. As illustrated in FIG. 1, the method includes a satellite 100. Specifically, the satellite 100 is a LIDAR satellite. As described above, LIDAR is an acronym for light detection and ranging, which is a remote sensing method that uses light in the form of a pulsed laser to measure ranges, in variable distances, to the Earth. The light pulses, combined with other recorded data generate precise three-dimensional information about the shape the Earth and its surface characteristics. Although FIG. 1 illustrates a LIDAR satellite 100, the lidar system may be coupled to a helicopter, plane, drone or other similar aerial device for capturing images. As further illustrated in FIG. 1 and depicted by the arrows, the satellite 100 may receive geographic data 102 from the Earth. As defined herein, geographic data 102 refers to information that is associated with specific geographic locations on the Earth's surface. It may include data related to the physical features, attributes, and phenomena of the Earth's surface, such as landforms, elevation, water bodies, transportation networks, buildings, utility distribution networks, and other spatially referenced objects. The geographic data 102 may be collected in various forms. For example, the geographic data 102 may be received as vector data, raster data, satellite imagery, aerial photography, LIDAR data, digital elevation models, geospatial imagery, geospatial sensor data, or geospatial metadata.

As further illustrated in FIG. 1 and depicted by the arrows the satellite 100 receives a first LIDAR imagery data 104 from a coordinate location 106. The first LIDAR imagery data 104 is a single capture of data regarding vegetation growth of a particular coordinate location 106. The coordinate location 106 is a specific and defined latitudinal and longitudinal location of a surface area of the Earth. The coordinate location 106 may range anywhere from ten square feet to one square mile of surface area. Here, as illustrated in FIG. 1, the image depicts vegetation growth along a utility distribution line which is captured by the satellite 100 and is stored on a database (not illustrated) installed on a server 108. Specifically, the geographic data 102 and first LIDAR imagery data 104 of a coordinate location 106 is stored on the database installed on the server 108. Although, FIG. 1 depicts a server 108, the database may be installed on a desktop computer, laptop, smart-handheld device, smart mobile device or other similar device capable of operating a database and communicating through a network 110.

The data received by the satellite 100 (i.e., geographic data 102, first LIDAR imagery data 104, and coordinate location 106) travels through the network 110 coupled to the server 108. In one or more embodiments, the network 110 may be a combination of a wired network, wireless network, radio frequency network or other similar network capable of coupling electronic devices for data communication and transfer.

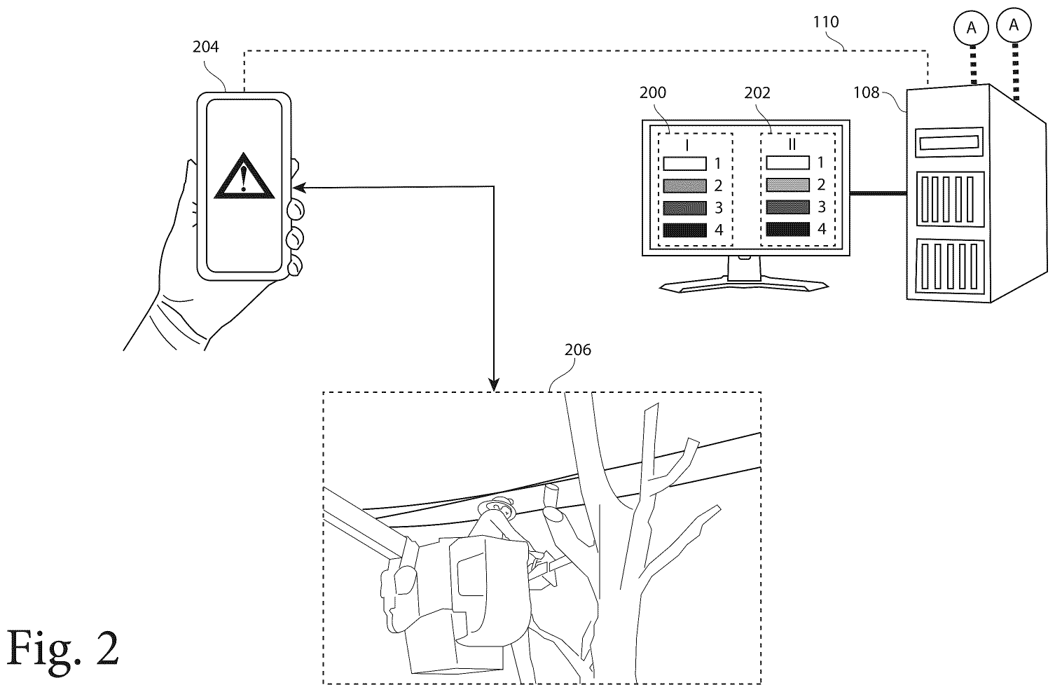

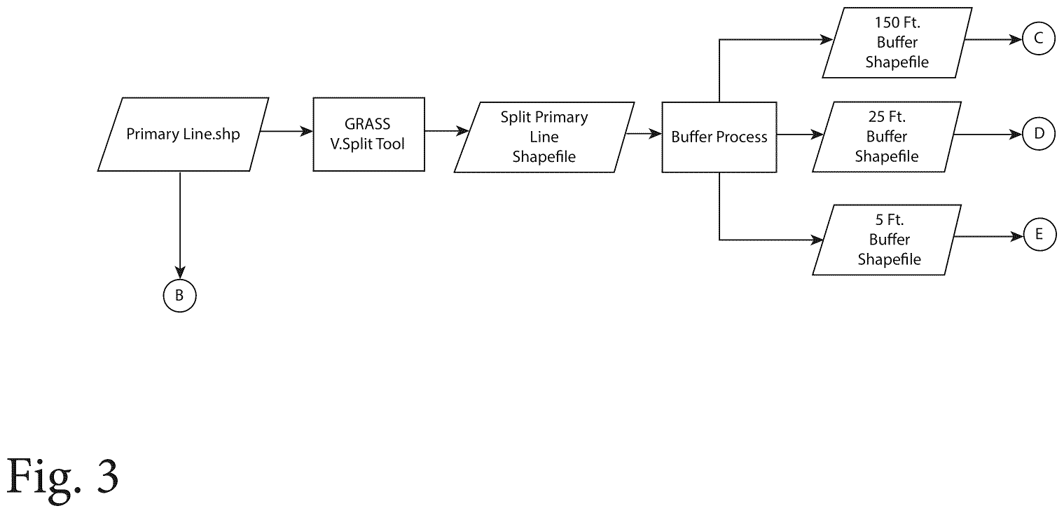

Although FIGS. 3-9 describes in the detail the method by which the data is analyzed, FIG. 2 is a schematic illustration of a flow chart showing a server receiving geographic data, a LIDAR imagery data, and a coordinate location, and alerting a device 204 that subsequently dispatches an entity. That is, FIG. 2 illustrates the method that occurs after the data is analyzed. For example, in one or more embodiments, a processor installed on the server 108 assigns a first threat level 200 to the first LIDAR imagery data 104. The first threat level 200 is a measurement of a vegetation in relations to the utility distribution network. That is, specifically how close is the vegetation growth from damaging the utility distribution network.

Once the first LIDAR imagery data 104 is given a first threat level 200, then, as illustrated in FIG. 1, the satellite 100 receives, again, the same geographic data 102 from the same coordinate location 106. However, the satellite 100 will receive a second LIDAR imagery data that should depict a change in vegetation growth along the utility distribution network. The time allocated between a first data set and a second data set can range from a 24-hour period to a one-year period or more. Although the method references two data sets (i.e., first LIDAR imagery data 104 compared with the second LIDAR imagery data), this method could compare (and assign threat levels) with an exorbitant number of comparable data sets.

Once the second LIDAR imagery data is received, the geographic data 102 from the coordinate location 106 is stored in the database installed on the server 108 along with the second LIDAR imagery data. The processor analyzes the data and assigns a second threat level 202. The second threat level 202 is a measurement of a vegetation in relations to the utility distribution network. That is, specifically how close is the vegetation growth from damaging the utility distribution network. In one or more embodiments, the first threat level 200 and the second threat level 202 are compared to determine a critical threat level. The critical threat level is the factor (i.e., measurement between the first threat level 200 and the second threat level 202) that determines the severity of the vegetation overgrowth along the utility distribution network. If a critical threat level is reached or determined, then a device 204 (such as a mobile phone) is alerted or notified. The notification alert message could be dispatched in the form of a sound, an email, text message, automated phone call or notification pushed by a downloadable application installed on the mobile device. The device 204 may be owned by an entity, such as a utility distribution and power organization or an independent contracting utility line worker. In one or more embodiments, the device 204 includes a geotracking software, such that the device 204 that is located closest to the coordinate location 106 having the critical threat level is first dispatched to eliminate the threat 206. The threat 206 can be eliminated by the entity being dispatched to the coordinate location 106 and removing the vegetation from the utility distribution network. Alternately, in situations where an entity is unable to be dispatched to the coordinate location 106 in a timely or safe fashion, the system and method may insulate the utility distribution network by either shutting off power through that electrical line or rerouting power away from that area until the vegetation growth is eliminated.

As described above, the method by which the processor analyzes and process the data (i.e., geographic data 102, first LIDAR imagery data 104, second LIDAR imagery data, coordinate location 106) through algorithms is illustrated in FIGS. 3-8. Note, FIGS. 3-8 comprises one entire method but is broken-up into sections for clarity. As noted above, the data received by the satellite 100 may come in different forms, such as vector files, which is outlined in FIG. 3. For example, the first and foremost major input may include a Primary Line shapefile (*.shp). The primary line.shp is a georeferenced vector-based file which is used to determine the location of primary electrical lines along a utility distribution network.

The primary line.shp file is processed by a vector processing tool, such as GRASS V.Split Tool. This is a specific tool derived from the geoprocessing python package GRASS that divides polylines (such as Primary Line.shp file) into equal parts of twenty-five feet. Thus, producing the Split Primary Line Shapefile as an output for use in the subsequent Buffer process.

The Buffer process uses a built-in arcpy python function library to create a buffer around the Split Primary Line Shapefile. This process creates three buffers of varying widths of 150 feet, 25 feet, and 5 feet Buffer Shapefiles.

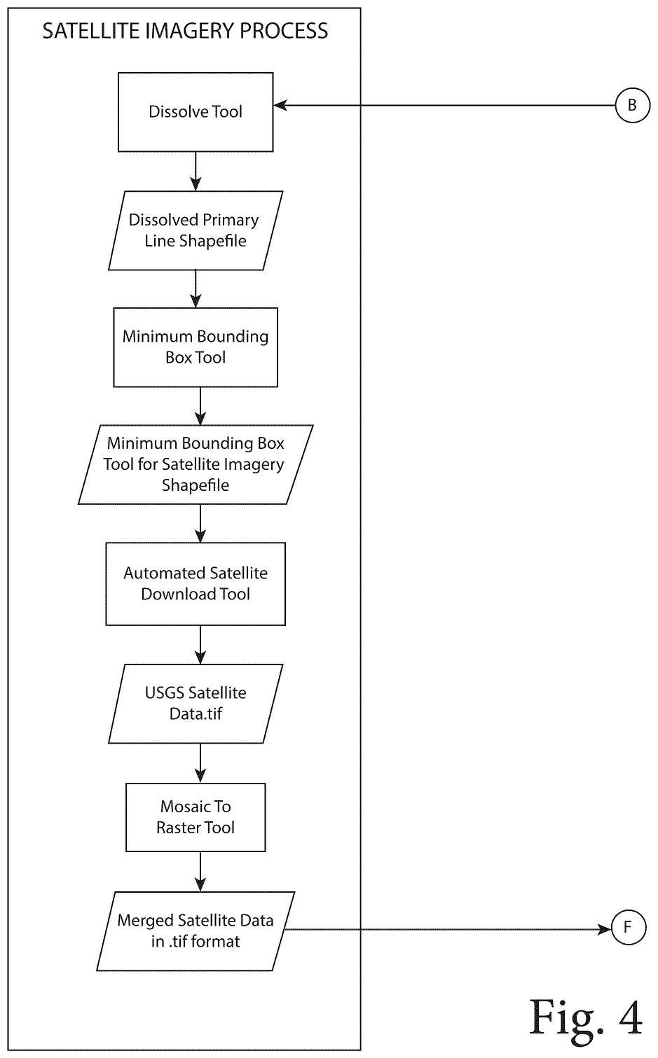

FIG. 4 illustrates the Satellite Imagery Processing. This section of the method requires a Dissolve Tool that takes the Primary Line.shp shapefile and dissolves all the polygons into one, which then becomes the dissolved Primary Line Shapefile. As further illustrated in FIG. 4, a Minimum Bounding Box Tool creates a bounding box that completely surrounds the entire dissolved Primary Line Shapefile. This box is a polygon that is rectangular in shape that is used as the area of interest for satellite download, which is subsequently identified as the Minimum Bounding Box for Satellite Imagery shapefile.

An automated Satellite Download Tool is then used to take the Minimum Bounding Box for Satellite Imagery Shapefile and runs it through an application programming interface (API) to receive satellite imagery data. This data is then downloaded in tag image file (*.tif) format and named after the specific file format year_month_day_imagery_type and is subsequently sent to a specified folder where they are Mosaiced. The Mosaic To Raster Tool, as illustrated in FIG. 4, converts the different mosaics into one raster. The merged satellite imagery is then converted into a single tag image file format.

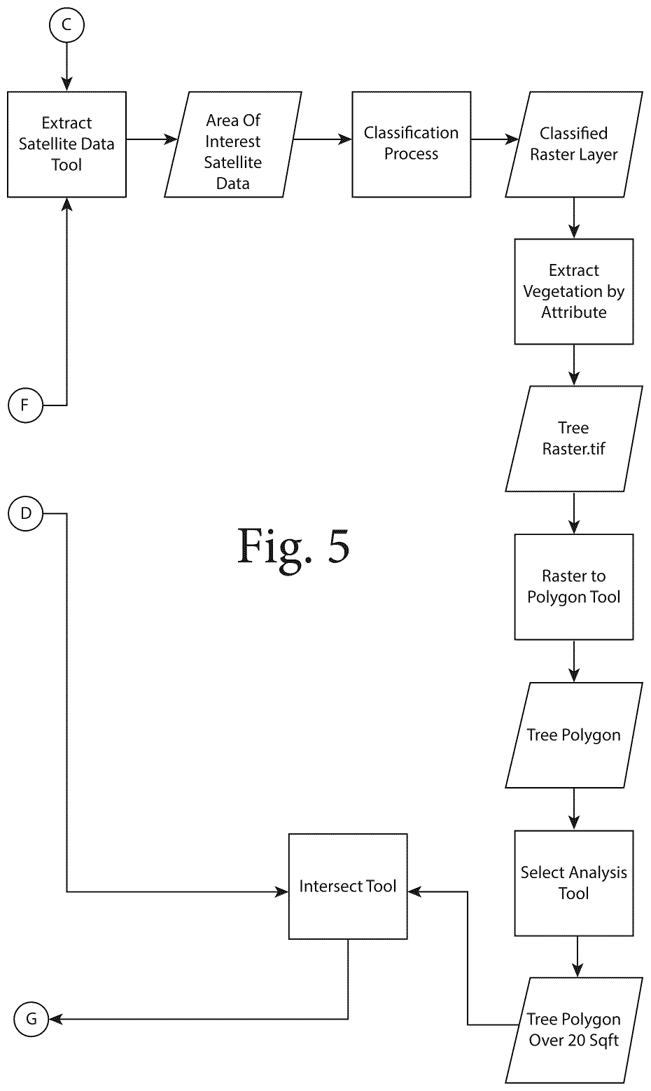

Next, as illustrated in FIG. 5, an Extract Satellite Data Tool is used to make use of the 150-foot Buffer Shapefile polygon to extract the satellite imagery that is within this buffer, which results in the creation of the Area of Interest Satellite Data Raster. Following this step, involves the Classification Process. The Classification process uses imagery analysis artificial intelligence (AI) and a set of training polygons to create a new raster that has categorized the land use. Using training polygons that are polygons created within features that train the Imagery Analysis AI what to consider specific pixels in the satellite imagery. This classification process creates a raster with classifications including man-made object, trees, shadows, grass, and dirt for example. This section the process is categorized as the Classified Raster Layer.

As further illustrated in FIG. 5, following the classification process and subsequent Classified Raster Layer creation, an Extract Vegetation by Attribute tool is executed. The Extract vegetation by Attribute tool is a process that is used on the classified raster layer and extracts only the pixels that have been given a value associated with trees by the imagery analysis AI. This data is then extracted from the raster into its own so that only pixels with a value associated with a tree is in the new raster called Tree Raster.tif.

Then, a Raster to Polygon Tool is executed. The raster to polygon tool converts a raster, a pixel-based image into a polygon, a line/vector-based shape. Executing this tool on the Tree Raster.tif file creates polygons that are shaped where vegetation growth exists from the time the satellite imagery is taken. This creates a Tree polygon shapefile.

Once the Tree polygon shapefile is created, then a Select Analysis Tool is executed. The Select Analysis Tool trims redundant or small polygons down from the tree polygon as each tree begins a polygon. Be deleting tree polygons that are under 20 square feet in size and extracting them allows the removal of much of the smaller vegetation. These tree polygons greater than 20 square feet in size are then extracted polygons that are greater than twenty square feet are then named Tree Polygon Over 20Sqft.shp.

Finally, as illustrated in FIG. 5, an Intersect Tool is executed. The Intersect Tool finds the intersection between the twenty-five-foot Buffer Shapefile created in the buffer process with the Tree Polygon over 20Sqft. This then creates a shapefile where there is overlap between these two shapefiles. This overlap shapefile is identified as the Intersect of Tree Polygons Within 25 Ft Buffer Shapefile.

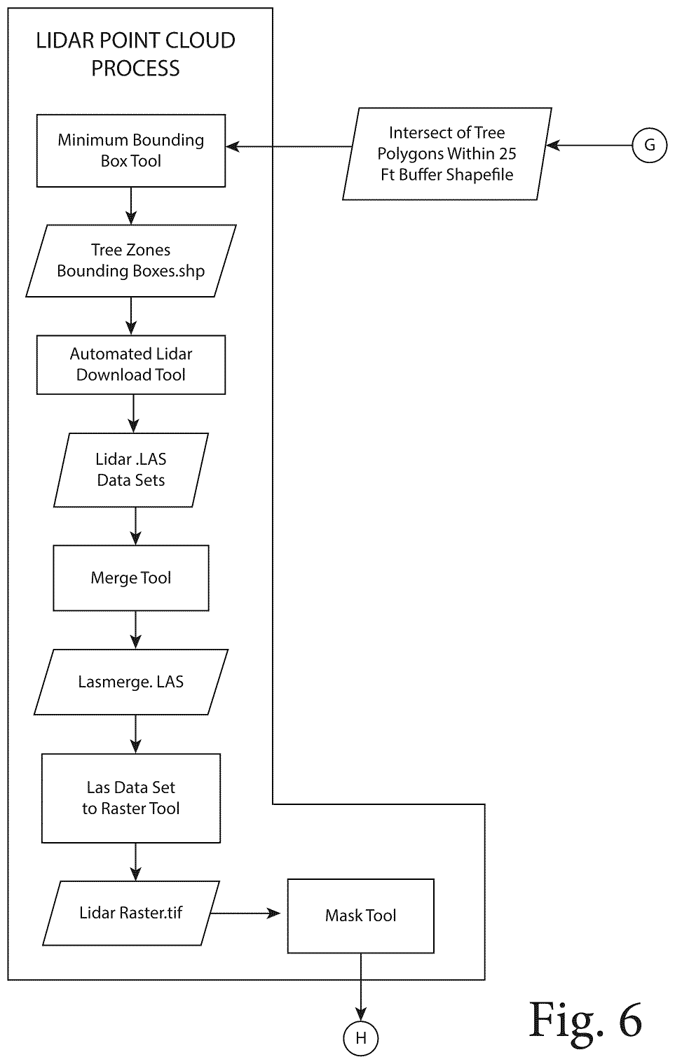

FIG. 6 illustrates the method used in the LIDAR Point Cloud Process. The LIDAR Point Cloud Process first begins with the execution of the Minimum Bounding Box Tool. The Minimum Bounding Box Tool is then used on the shapefile intersect of the Tree Polygons Within 25 Ft Buffer Shapefile resulting in the creation of a bounding box around each polygon. This bounding box polygon is identified as Tree Zones Bounding Boxes.shp.

Following is the execution of an Automated LIDAR Download Tool. The Automated LIDAR download tool takes the Tree Zones Bounding Boxes polygons and iterates over them downloading LIDAR point shape from an object storage service. A Laser format file (i.e., *.las) is created for each tree polygon. This collection of laser format data sets is identified as Lidar.Las Datasets.

The Lidar.LAS Datasets are then merged using a Merge Tool. The datasets are merged using a python package service that combines all of the datasets into one point cloud file type. In turn, every Lidar.Las Data Set is combined to create a single *.las file identified as Lasmerge.LAS.

Finally, as illustrated in FIG. 6, the LIDAR point cloud process is completed with the execution of the Mask Tool. The Mask Tool extracts the parts of the Lidar Raster.tif pixels that fall within a five foot buffer of the primary line created through the buffer process—the product of which is the 5 Ft Buffer Shapefile. The product of this tool is the pixels holding elevation data only within the 5 Ft Buffer Shapefile. This is identified as the ThreatBufferRaster.tif. file.

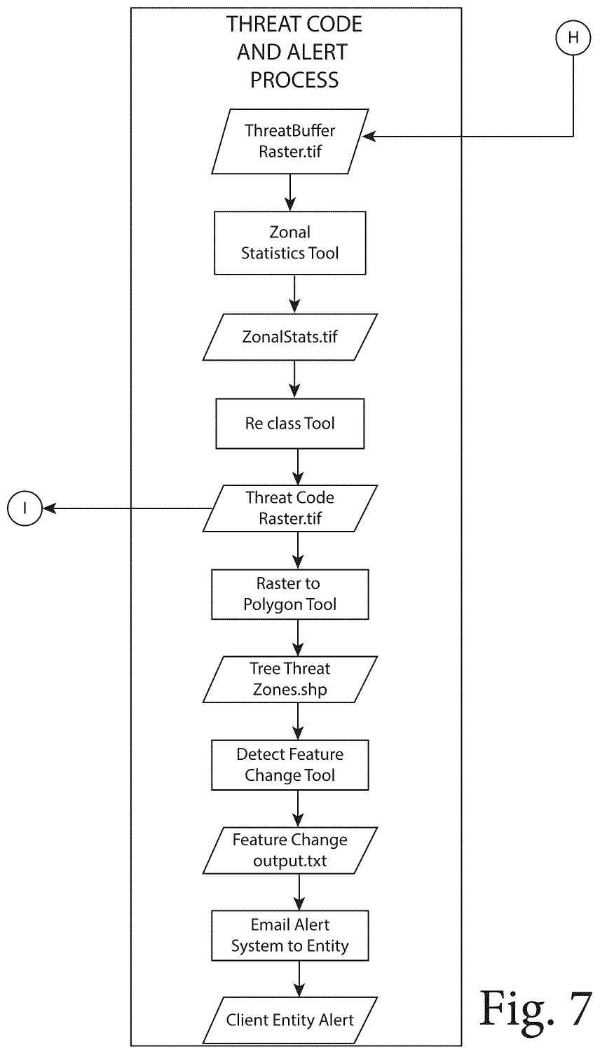

FIG. 7 illustrates the Threat Code Alert Process. This process begins with a Zonal Statistics Tool. The Zonal Statistics Tool uses ThreatBufferRaster.tif as an input to count the number of elevation pixels within a certain height within five feet above or below the height of the primary power line. This process creates a raster per span of the pixel count identified as the Zonalstats.tif.

After the Zonalstats.tif file is created, a Re class Tool is executed. The Re class Tool takes the Zonalstats.tif file raster image and reclasses it based on the elevation pixel values inside. This elevation is based on a tier system with 1 being the lowest and 5 being the highest threat. The tier system may be amended based on application. Once the reclassed is complete, the final file becomes the Threat Code Raster.tif. The Raster to Polygon Tool is then executed to convert the rasterized Threat Code Raster.tif into a polygon where it becomes vector based and manipulatable. The data file then becomes the Tree Threat Zones.shp.

Next, a Detect Feature Change Tool is executed. The Detect Feature Change Tool uses change detection to compare satellite imagery from separate time events in the same threat zones to alert if a tree has been trimmed, the tree's health status, such as the Normalized Difference Vegetation Index (NDVI) rating in case of disease or lightning strike. A text file is generated summarizing the differences identified as Feature Change output.txt. Alerts can be triggered by human responses or changes to the job description of Tree Threat Zones on the device 204.

Finally, the Threat Code and Alert Process, illustrated in FIG. 7 is completed with an Email Alert to the Entity. Alerts can be emailed directly to a utility line worker or the utility distribution organization.

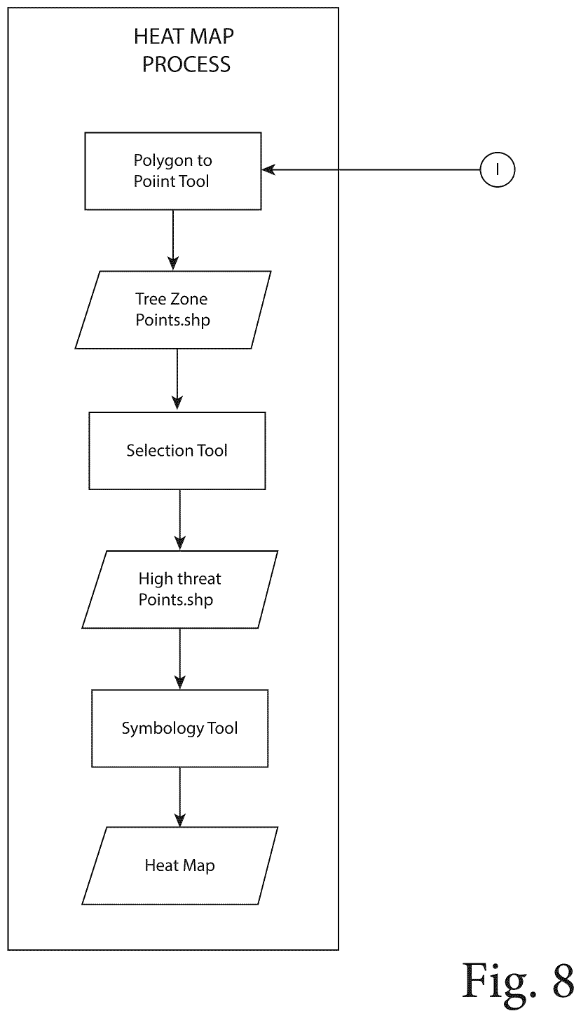

FIG. 8 is the Heat Map Process, which involves the use of converting tree threat zone shapes into points. The process begins with the execution of a Polygon to Point Tool. The Polygon to Point Tool converts the Threat Zones.shp into points by using the center point of their shape polygon-creating Tree Zone Points.shp.

Next, the selection tool is used to select points that have a threat value of four and five as determined through the Re class Tool in this process. This subset of points is saved and identified as High Threat Points.shp.

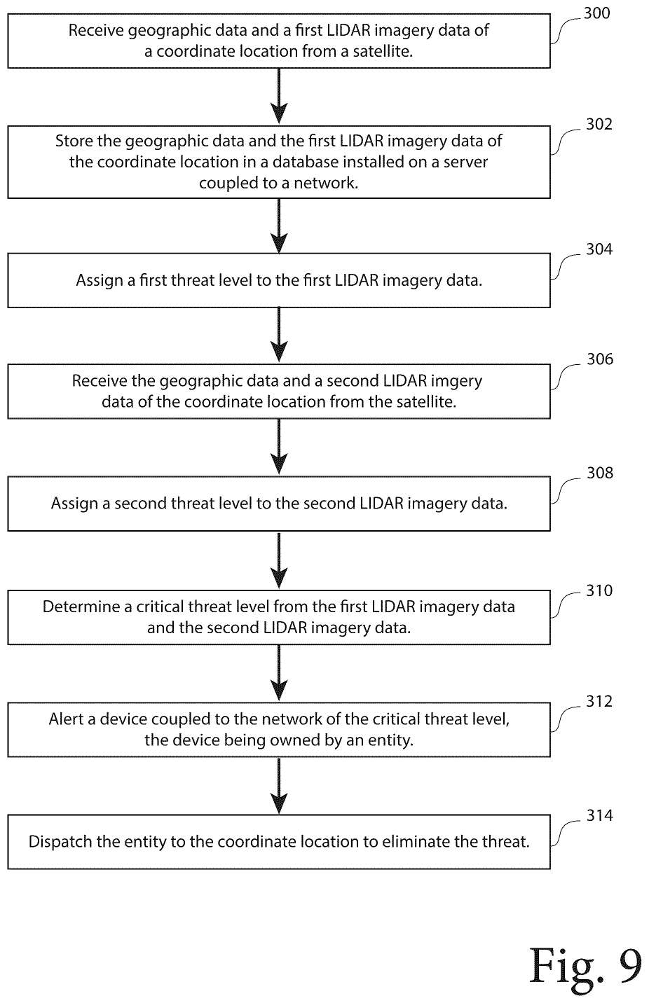

Finally, as illustrated in FIG. 9, a Symbology Tool is executed to add visualizations to the points by creating a matrix of represented colors through a gradient effect and color coding.

FIG. 9 is a flow chart of a method of determining a critical threat level from geographic data, LIDAR imagery data, and a coordinate location. In operation, a geographic data (such as geographic data 102), a first LIDAR imagery data (such as first LIDAR imagery data 104) of a coordinate location (such as coordinate location 106) is received from a satellite (such as satellite 100) (block 300). The geographic data (such as geographic data 102) and the first LIDAR imagery data (such as first LIDAR imagery data 104) of the coordinate location (such as coordinate location 106) is stored in a database installed on a server (such as server 108) coupled to a network (such as network 110) (block 302). A first threat level (such as first threat level 200) is assigned to the first LIDAR imagery data (such as first LIDAR imagery data 104) (block 304). The geographic data (such as geographic data 102) and a second LIDAR imagery data of the coordinate location (such as coordinate location 106) is received from the satellite (such as satellite 100) (block 306). A second threat level (such as second threat level 202) is assigned to the second LIDAR imagery data (block 308). A critical threat level is determined from the first LIDAR imagery data (such as first LIDAR imagery data 104) and the second LIDAR imagery data (block 310). A device (such as device 204) coupled to the network (such as network 110) is alerted of the critical threat level, the device (such as device 204) being owned by an entity (block 312). The entity is dispatched to the coordinate location (such as coordinate location 106) to eliminate the threat (such as threat 206) (block 314).

In one aspect, a method for determining a threat level for vegetation overgrowth includes receiving geographic data and a first LIDAR imagery data of a coordinate location from a satellite. Geographic data and the first LIDAR imagery data of a coordinate location is stored in a database installed on a server coupled to a network. A first threat level is assigned to the first LIDAR imagery data. The geographic data and a second LIDAR imagery data of the coordinate location is received from the satellite. The geographic data and the second LIDAR imagery date of the coordinate location is stored in the database. A second threat level is assigned to the second LIDAR imagery data. A critical threat level is determined from the first LIDAR imagery data and the second LIDAR imagery data. A device coupled to the network is alerted of the critical threat level. The device is owned by an entity. The entity is dispatched to the coordinate location to eliminate the threat.

Implementation may include one or more of the following. The geographic data may further include a utility distribution network. An electrical current flowing through the utility distribution network may be insulated when the critical threat level is determined. The first threat level may be a measurement of a vegetation in relation to the utility distribution network. The second threat level may be a measurement of a vegetation in relation to the utility distribution network. The critical threat level may be a change in measurement between the first threat level and the second threat level in relation to the utility distribution network. The critical threat level may be determined by a processor installed on the server. The entity may be a utility line worker. The entity may be a utility and distribution and power organization. The device may include geotracking software, such that the device located closest to the coordinate location having the critical threat level is first dispatched to eliminate the threat.

In one aspect, a non-transitory computer-readable medium on which is recorded a computer program, the program comprising executable instructions, that when executed, performs a method for determining a threat level for vegetation overgrowth includes receiving geographic data and a first LIDAR imagery data of a coordinate location from a satellite. Geographic data and the first LIDAR imagery data of a coordinate location is stored in a database installed on a server coupled to a network. A first threat level is assigned to the first LIDAR imagery data. The geographic data and a second LIDAR imagery data of the coordinate location is received from the satellite. The geographic data and the second LIDAR imagery date of the coordinate location is stored in the database. A second threat level is assigned to the second LIDAR imagery data. A critical threat level is determined from the first LIDAR imagery data and the second LIDAR imagery data. A device coupled to the network is alerted of the critical threat level. The device is owned by an entity. The entity is dispatched to the coordinate location to eliminate the threat.

Implementation may include one or more of the following. The geographic data may further include a utility distribution network. An electrical current flowing through the utility distribution network may be insulated when the critical threat level is determined. The first threat level may be a measurement of a vegetation in relation to the utility distribution network. The second threat level may be a measurement of a vegetation in relation to the utility distribution network. The critical threat level may be a change in measurement between the first threat level and the second threat level in relation to the utility distribution network. The critical threat level may be determined by a processor installed on the server. The entity may be a utility line worker. The entity may be a utility and distribution and power organization. The device may include geotracking software, such that the device located closest to the coordinate location having the critical threat level is first dispatched to eliminate the threat.

The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for determining a threat level for vegetation overgrowth comprising:
receiving geographic data and a first LIDAR imagery data of a coordinate location from a satellite;
storing the geographic data and the first LIDAR imagery data of the coordinate location in a database installed on a server coupled to a network;
assigning a first threat level to the first LIDAR imagery data;
receiving the geographic data and a second LIDAR imagery data from the coordinate location from the satellite;
storing the geographic data and the second LIDAR imagery data of the coordinate location in the database;
assigning a second threat level to the second LIDAR imagery data;
determining a critical threat level from the first LIDAR imagery data and the second LIDAR imagery data;
alerting a device coupled to the network of the critical threat level, the device being owned by an entity;
dispatching the entity to the coordinate location to eliminate the threat.

2. The method of claim 1 wherein the geographic data further includes a utility distribution network.

3. The method of claim 2 wherein an electrical current flowing through the utility distribution network is insulated when the critical threat level is determined.

4. The method of claim 2 wherein the first threat level is a measurement of a vegetation in relation to the utility distribution network.

5. The method of claim 3 wherein the second threat level is a measurement of the vegetation in relation to the utility distribution network.

6. The method of claim 4 wherein the critical threat level is a change in measurement between the first threat level and the second threat level in relation to the utility distribution network.

7. The method of claim 1 wherein the critical threat level is determined by a processor installed on the server.

8. The method of claim 1 wherein the entity is a utility line worker.

9. The method of claim 1 wherein the entity is a utility distribution and power organization.

10. The method of claim 1 wherein the device includes a geotracking software, such that the device that is located closest to the coordinate location having the critical threat level is first dispatched to eliminate the threat.

11. A non-transitory computer-readable medium on which is recorded a computer program, the program comprising executable instructions, that when executed, perform a method for determining a threat level for vegetation overgrowth comprising:
receiving geographic data and a first LIDAR imagery data of a coordinate location from a satellite;
storing the geographic data and the first LIDAR imagery data of the coordinate location in a database installed on server coupled to a network;
assigning a first threat level to the first LIDAR imagery data by a processor installed on the server;
receiving the geographic data and a second LIDAR imagery data from the coordinate location from the satellite;
storing the geographic data and the second LIDAR imagery data of the coordinate location in the database;
assigning a second threat level to the second LIDAR imagery data by the processor;
determining a critical threat level from the first LIDAR imagery data and the second LIDAR imagery data by the processor;
alerting a device coupled to the network of the critical threat level, the device being owned by an entity;
dispatching the entity to the coordinate location to eliminate the threat by the processor.

12. The non-transitory computer-readable medium of claim 11 wherein the geographic data further includes a utility distribution network.

13. The non-transitory computer-readable medium of claim 11 wherein an electrical current flowing through the utility distribution network is insulated when the critical threat level is determined.

14. The non-transitory computer-readable medium of claim 12 wherein the first threat level is a measurement of a vegetation in relation to the utility distribution network.

15. The non-transitory computer-readable medium of claim 13 wherein the second threat level is a measurement of the vegetation in relation to the utility distribution network.

16. The non-transitory computer-readable medium of claim 14 wherein the critical threat level is a change in measurement between the first threat level and the second threat level in relation to the utility distribution network.

17. The non-transitory computer-readable medium of claim 11 wherein the critical threat level is determined by a processor installed on the server.

18. The non-transitory computer-readable medium of claim 11 wherein the entity is a utility line worker.

19. The non-transitory computer-readable medium of claim 11 wherein the entity is a utility distribution and power organization.

20. The non-transitory computer-readable medium of claim 11 wherein the device includes a geotracking software, such that the device that is located closest to the coordinate location is dispatched to eliminate the critical threat.
